(19) United States
(12) Patent Application Publication
(10) Pub. No.: US 2025/0372763 A1
(43) Pub. Date: Dec. 4, 2025

(54) DUCT STRUCTURE FOR AN AIR-COOLED BATTERY

(71) Applicants: HYUNDAI MOTOR COMPANY, SEOUL (KR); KIA CORPORATION, SEOUL (KR)

(72) Inventors: Seon Ung Youn, Hwaseong-si (KR); Kwang Ok Jeon, Hwaseong-si (KR)

(73) Assignees: HYUNDAI MOTOR COMPANY, SEOUL (KR); KIA CORPORATION, SEOUL (KR)

(21) Appl. No.: 18/934,572

(22) Filed: Nov. 1, 2024

(30) Foreign Application Priority Data
Jun. 4, 2024 (KR) 10-2024-0073289

(51) Int. Cl. H01M 10/6566; B60K 1/04; B60N 3/04; H01M 10/613; H01M 10/625; H01M 10/6563

(52) U.S. Cl. CPC H01M 10/6566; B60K 1/04; B60N 3/048; H01M 10/613; H01M 10/625; B60K 2001/0438; H01M 10/6563

(57) ABSTRACT

A duct structure for an air-cooled battery including a duct configured to guide air flowing out from a battery assembly disposed under a floor of a vehicle in a longitudinal direction of the vehicle, and a carpet pad covering the duct, where the carpet pad includes a guide passage extending from a portion of the carpet pad adjacent to the duct to a side edge of the floor.

### CROSS REFERENCE TO RELATED APPLICATIONS

This application is based on and claims the benefit of priority to Korean Patent Application No. 10-2024-0073289, filed on Jun. 4, 2024, in the Korean Intellectual Property Office, the disclosure of which is incorporated herein in its entirety by reference.

### TECHNICAL FIELD

The present disclosure relates to a duct structure for an air-cooled battery, and more particularly, to a duct structure for an air-cooled battery configured to guide heated air flowing out from a battery assembly of a vehicle to an edge of the vehicle, thereby preventing heat, noise, vibration, etc. from being delivered to passengers in a passenger compartment.

### BACKGROUND

An electric vehicle or hybrid vehicle may include a battery disposed under a floor, and a battery cooling system for maintaining the battery at an appropriate temperature.

The performance of high-voltage components including the battery may vary depending on temperature, so it is important to maintain the high-voltage components at appropriate temperatures. The battery of the vehicle may be classified into an air-cooled battery system which is cooled by air and a liquid-cooled battery system which is cooled by liquid.

The air-cooled battery system may be configured to cool the battery using indoor air of the vehicle. A battery assembly may be disposed under the floor, and the battery assembly may include a battery case and a plurality of battery cells disposed inside the battery case. An air intake grille may be provided in the floor, and the air may be sucked from the interior of the vehicle into an interior space of the battery case through the air intake grille by the operation of a cooling fan. As the sucked air passes through the interior space of the battery case, the plurality of battery cells may exchange heat with the air. The plurality of battery cells may be cooled to an appropriate temperature by the air, the air may be heated by the plurality of battery cells, and the heated air may flow out from the battery case. The heated air flowing out from the battery case may be discharged to the floor of the vehicle through an outlet duct. To prevent moisture and/or foreign objects from entering the outlet duct, the outlet duct may be mounted on a top surface of the floor in a longitudinal direction of the vehicle. When the heated air is discharged from the outlet duct to the floor, noise and vibration may be generated, and heat from the heated air may be delivered to passengers in a passenger compartment.

Securing the interior space of the vehicle may be essential to enhance marketability of the vehicle, and seat rails may be provided on the floor of the vehicle to mount independent vehicle seats. Due to the layout of the seat rails and the layout of vehicle body members and the like to ensure vehicle stiffness, it may be difficult to create a structure suitable to prevent noise, vibration, and heat of the air discharged from the outlet duct from being delivered to the passengers.

The above information described in this background section is provided to assist in understanding the background of the inventive concept, and may include any technical concept which is not considered as the prior art that is already known to those skilled in the art.

### SUMMARY

The present disclosure has been made to solve the above-mentioned problems occurring in the prior art while advantages achieved by the prior art are maintained intact.

An aspect of the present disclosure provides a duct structure for an air-cooled battery configured to guide heated air flowing out from a battery assembly of a vehicle to an edge of the vehicle, thereby preventing heat, noise, vibration, etc. from being delivered to passengers in a passenger compartment.

According to an aspect of the present disclosure, a duct structure for an air-cooled battery may include a duct configured to guide air flowing out from a battery assembly disposed under a floor of a vehicle in a longitudinal direction of the vehicle; and a carpet pad covering the duct. The carpet pad may include a guide passage extending from a portion of the carpet pad adjacent to the duct to a side edge of the floor.

The guide passage may have a groove-shaped cross section recessed from a bottom surface of the carpet pad toward a top surface of the carpet pad.

The carpet pad may be made of a foam material.

The duct structure may further include a carpet skin covering the carpet pad. The carpet skin may be made of a fabric material.

The duct may include a pair of outlet openings which are open to both sides of the vehicle.

The duct may further include at least one outlet hole provided between the pair of outlet openings.

The guide passage may extend from the portion of the carpet pad adjacent to the outlet hole to the side edge of the floor.

### BRIEF DESCRIPTION OF THE FIGURES

The above and other objects, features and advantages of the present disclosure will be more apparent from the following detailed description taken in conjunction with the accompanying drawings:

FIG. 1 illustrates a plan view of a duct structure for an air-cooled battery according to an exemplary embodiment of the present disclosure;

FIG. 2 illustrates a cross-sectional view, taken along line A-A of FIG. 1;

FIG. 3 illustrates a state in which a second duct is connected to guide passages of a carpet pad in a rear area of a duct structure for an air-cooled battery according to an exemplary embodiment of the present disclosure;

FIG. 4 illustrates a cross-sectional view, taken along line B-B of FIG. 3;

FIG. 5 illustrates a cross-sectional view, taken along line C-C of FIG. 3;

FIG. 6 illustrates a cross-sectional view, taken along line D-D of FIG. 3;

FIG. 7 illustrates a perspective view of guide passages provided in a bottom surface of a carpet pad in a duct structure for an air-cooled battery according to an exemplary embodiment of the present disclosure;

FIG. 8 illustrates an enlarged view of a rear portion of a second duct of a duct structure for an air-cooled battery according to an exemplary embodiment of the present disclosure;

FIG. 9 illustrates an enlarged view of a rear portion of a second duct of a duct structure for an air-cooled battery according to another exemplary embodiment of the present disclosure; and

FIG. 10 illustrates an enlarged view of a rear portion of a second duct of a duct structure for an air-cooled battery according to another exemplary embodiment of the present disclosure.

### DETAILED DESCRIPTION

Hereinafter, exemplary embodiments of the present disclosure will be described in detail with reference to the accompanying drawings. In the drawings, the same reference numerals will be used throughout to designate the same or equivalent elements. In addition, a detailed description of well-known techniques associated with the present disclosure will be ruled out in order not to unnecessarily obscure the gist of the present disclosure.

Terms such as first, second, A, B, (a), and (b) may be used to describe the elements in exemplary embodiments of the present disclosure. These terms are only used to distinguish one element from another element, and the intrinsic features, sequence or order, and the like of the corresponding elements are not limited by the terms. Unless otherwise defined, all terms used herein, including technical or scientific terms, have the same meanings as those generally understood by those with ordinary knowledge in the field of art to which the present disclosure belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

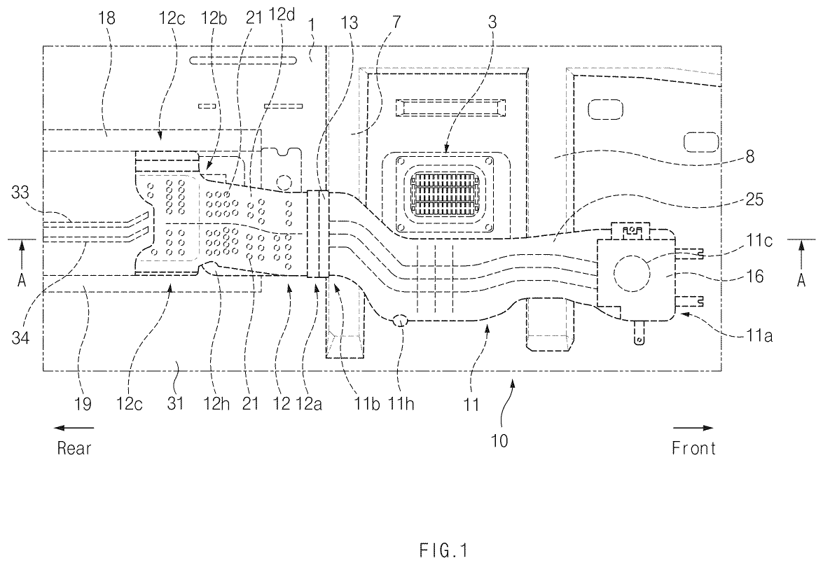

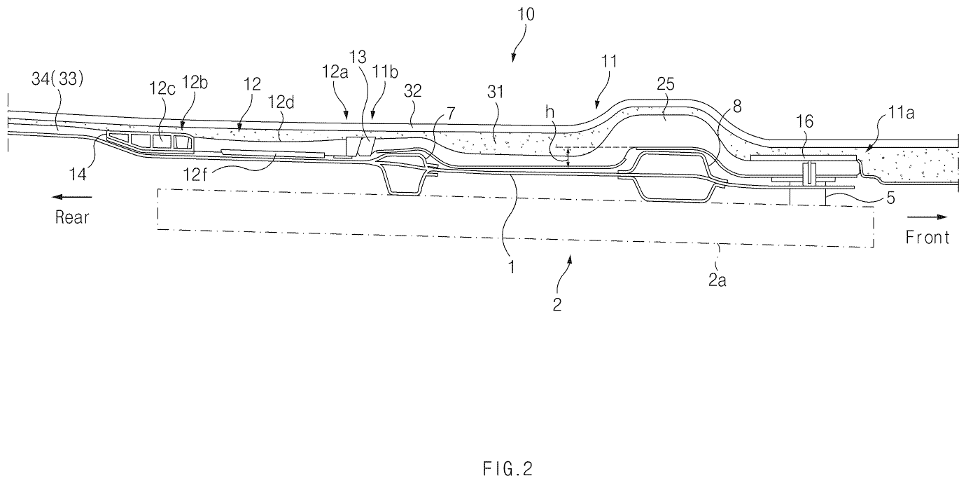

Referring to FIGS. 1 and 2, a duct structure 10 for a vehicle air-cooled battery according to an exemplary embodiment of the present disclosure may be mounted on a top surface of a floor 1 of a vehicle. The duct structure 10 may include one or more ducts 11 and 12 extending in a longitudinal direction of the vehicle, and a carpet pad 31 covering the ducts 11 and 12 and the floor 1.

Referring to FIG. 1, an air intake grille 3 may be provided to the floor 1. Referring to FIG. 2, a battery case 2a of a battery assembly 2 may be disposed under the floor 1. A plurality of battery cells may be disposed in an interior space of the battery case 2a.

The air intake grille 3 may fluidly communicate with an inlet of the battery case 2a, and indoor air may be sucked into the interior space of the battery case 2a through the air intake grille 3 by the operation of a cooling fan (not shown). The air sucked into the interior space of the battery case 2a may exchange heat with the plurality of battery cells so that the plurality of battery cells may be cooled, and the air may absorb heat from the plurality of battery cells so that the air may be heated. The heated air may flow out from the battery case 2a, and the air flowing out from the battery case 2a may be discharged and guided to the floor 1 of the vehicle through the duct structure 10.

One or more ducts 11 and 12 may be configured to guide the air flowing out from the battery case 2a of the battery assembly 2 along the longitudinal direction of the vehicle.

Referring to FIGS. 1 and 2, the duct structure 10 for a vehicle air-cooled battery may include a first duct 11 extending from the front of the vehicle toward the rear of the vehicle, and a second duct 12 extending from the first duct 11 toward the rear of the vehicle.

The first duct 11 may include a front portion 11a facing the front of the vehicle, and a rear portion 11b facing the rear of the vehicle. The first duct 11 may extend in the longitudinal direction of the vehicle. The first duct 11 may be fluidly connected to the battery assembly 2. Referring to FIG. 1, the front portion 11a of the first duct 11 may have a front opening 11c communicating with an outlet of the battery case 2a of the battery assembly 2. The front opening 11c of the first duct 11 may communicate with the outlet of the battery case 2a through a pipe 5. The air flowing out from the outlet of the battery case 2a may be directed into the front opening 11c of the first duct 11 through the pipe 5, and the air flowing into the front opening 11c may flow along a longitudinal direction of the first duct 11 in an interior space of the first duct 11. The first duct 11 may have at least one mounting lug 11h, and the first duct 11 may be fixed to the top surface of the floor 1 through the mounting lug 11h.

When the air flowing out from the outlet of the battery case 2a is directed into the front opening 11c of the first duct 11 through the pipe 5, the air flowing into the front opening 11c may hit the front portion 11a of the first duct 11, thereby generating noise. Referring to FIGS. 1 and 2, a noise absorbing material 16 may be mounted on the front portion 11a of the first duct 11, and the noise absorbing material 16 may absorb noise of the air flowing into the front opening 11c of the first duct 11 so that the generation of noise may be minimized.

Referring to FIGS. 1 and 2, the second duct 12 may include a front portion 12a facing the front of the vehicle, and a rear portion 12b facing the rear of the vehicle. The front portion 12a of the second duct 12 may be connected to the rear portion 11b of the first duct 11 so that they may communicate with each other. The second duct 12 may have at least one mounting lug 12h, and the second duct 12 may be fixed to the top surface of the floor 1 through the mounting lug 12h.

A pair of seat rails 18 and 19 may be disposed on both sides of the second duct 12, and seat mounts of a vehicle seat may be mounted on the pair of seat rails 18 and 19, respectively. The second duct 12 may have a pair of outlet openings 12c provided on both left and right sides of the rear portion 12b, respectively, and the pair of outlet openings 12c may be open to both sides of the vehicle, respectively. Specifically, the outlet openings 12c may be open to the corresponding seat rails 18 and 19. The air flowing in from the first duct 11 may flow along a longitudinal direction of the second duct 12 in an interior space of the second duct 12, and the air may be discharged toward the pair of seat rails 18 and 19 through the pair of outlet openings 12c.

The first duct 11 and the second duct 12 may be disposed on the top surface of the floor 1, and the carpet pad 31 may cover the entirety of the top surface of the floor 1 while covering the ducts 11 and 12 and peripheral regions of the ducts 11 and 12. Referring to FIG. 2, the carpet pad 31 may entirely cover the top surface of the floor 1, a top surface of the first duct 11, and a top surface of the second duct 12. A carpet skin 32 may be stacked on a top surface of the carpet pad 31. Accordingly, the first duct 11 and the second duct 12 may be covered with the carpet pad 31 and the carpet skin 32 above the floor 1, and the air discharged from the outlet openings 12c of the second duct 12 may be blocked by the carpet pad 31 and the carpet skin 32 from being delivered to passengers. That is, when the air flowing out from the battery case 2a of the battery assembly 2 is discharged to the floor 1 of the vehicle through the outlet openings 12c of the duct structure 10, the air may be blocked from being delivered to the passengers in a passenger compartment.

According to an exemplary embodiment, the carpet pad 31 may be made of a foam material such as a urethane-based material and a resin-based material, and the carpet skin 32 may be made of a fabric material.

The second duct 12 may have a plurality of holes 21 and 22 provided in a portion thereof adjacent to the outlet openings 12c, and at least a portion of the air may be discharged through the plurality of holes 21 and 22 before being discharged through the outlet openings 12c.

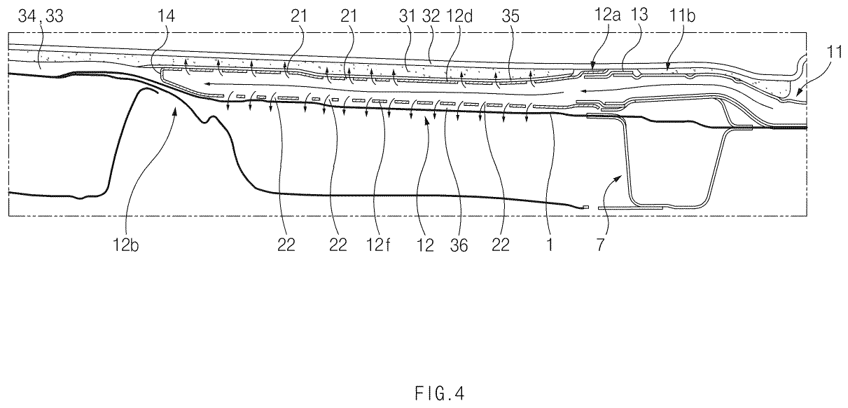

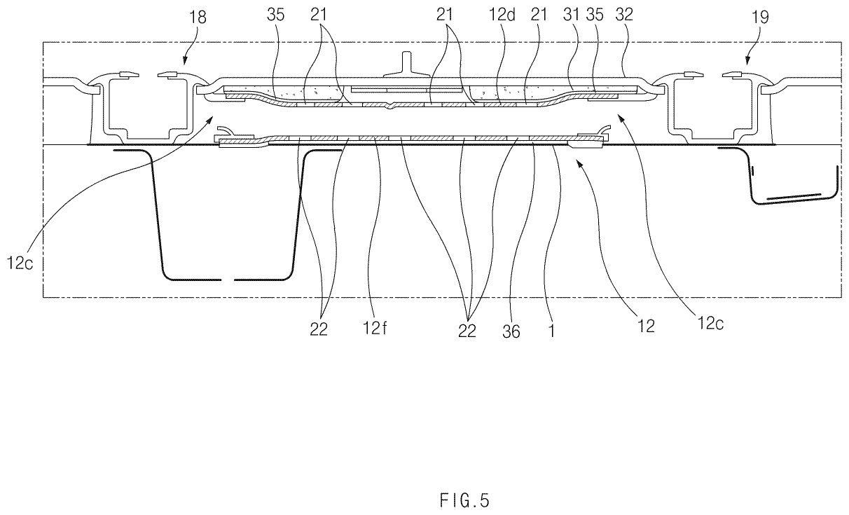

Referring to FIGS. 4 and 5, the second duct 12 may have a top wall 12d facing the top thereof. The top wall 12d of the second duct 12 may be spaced apart from the carpet pad 31 by a small gap, and accordingly an upper gap 35 may be formed between the carpet pad 31 and the top wall 12d of the second duct 12. The second duct 12 may have a plurality of upper holes 21 formed in the top wall 12d, and the plurality of upper holes 21 may face the carpet pad 31.

Each upper hole 21 may have a diameter less than an opening area of the outlet opening 12c. For example, the diameter of the upper hole 21 may be 12 mm, and when the diameter of the upper hole 21 is less than or equal to 12 mm, whistle noise may be generated or blockage of foreign objects may occur. The plurality of upper holes 21 may be uniformly disposed in the top wall 12d of the second duct 12. A portion of the air flowing along the longitudinal direction of the second duct 12 in the interior space of the second duct 12 may flow into the upper gap 35 between the carpet pad 31 and the top wall 12d through the plurality of upper holes 21. The plurality of upper holes 21 may move a noise frequency range (e.g., towards a frequency range outside of perceivable frequency range). The plurality of upper holes 21 moving the noise frequency range may therefore reduce noise perceivable by the passenger. A flow direction of the air passing through the plurality of upper holes 21 may be perpendicular to the longitudinal direction of the second duct 12.

Referring to FIGS. 4 and 5, the second duct 12 may have a bottom wall 12f facing the top wall 12d. The bottom wall 12f of the second duct 12 may be spaced apart from the floor 1 by a small gap, and accordingly a lower gap 36 may be formed between the floor 1 and the bottom wall 12f of the second duct 12. The second duct 12 may have a plurality of lower holes 22 formed in the bottom wall 12f, and the plurality of lower holes 22 may face the floor 1. Each lower hole 22 may have a diameter less than an opening area of the outlet opening 12c. For example, the diameter of the lower hole 22 may be 12 mm, and when the diameter of the lower hole 22 is less than or equal to 12 mm, whistle noise may be generated or blockage of foreign objects may occur. The plurality of lower holes 22 may be uniformly disposed in the bottom wall 12f of the second duct 12. A portion of the air flowing along the longitudinal direction of the second duct 12 in the interior space of the second duct 12 may flow into the lower gap 36 between the bottom wall 12f and the floor 1 through the plurality of lower holes 22. As the plurality of lower holes 22 are formed in the bottom wall 12f of the second duct 12, moisture flowing in through the plurality of upper holes 21 may be discharged through the plurality of lower holes 22. The plurality of lower holes 22 may move a noise frequency range (e.g., towards a frequency range outside of perceivable frequency range). The plurality of lower holes 22 moving the noise frequency range may therefore reduce noise perceivable by the passenger. A flow direction of the air passing through the plurality of lower holes 22 may be perpendicular to the longitudinal direction of the second duct 12.

As described above, at least a portion of the air may be discharged through the plurality of upper holes 21 and the plurality of lower holes 22 before being discharged through the outlet openings 12c so that pressure and air speed at the outlet openings 12c of the second duct 12 may be moderately changed, and pressure in the interior space of the second duct 12 may be relatively lowered. Accordingly, the generation of noise and/or vibration at the outlet openings 12c of the second duct 12 may be minimized. In addition, as the air is discharged through the outlet openings 12c, the plurality of upper holes 21, and the plurality of lower holes 22, the flow rate of the air discharged from the second duct 12 may relatively increase so that the flow rate of the air flowing into the battery case 2a of the battery assembly 2 may increase. Accordingly, the cooling of the plurality of battery cells (battery cooling performance) may be improved.

The second duct 12 may include one or more outlet holes 23 and 24 located between the pair of outlet openings 12c.

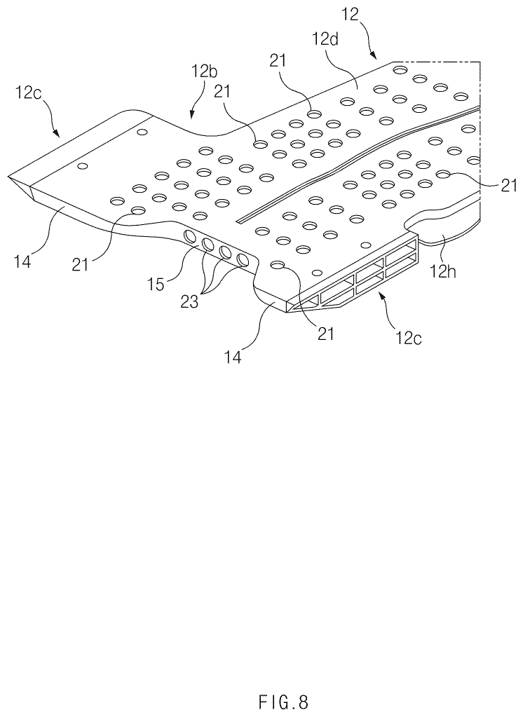

Referring to FIG. 8, the second duct 12 may have a rear end wall 14 provided on the rear portion 12b and a recessed wall 15 recessed from the rear end wall 14 toward the front portion 12a. A flat surface of the rear end wall 14 and a flat surface of the recessed wall 15 may be perpendicular to a longitudinal axis of the second duct 12. The plurality of outlet holes 23 may be provided in the recessed wall 15.

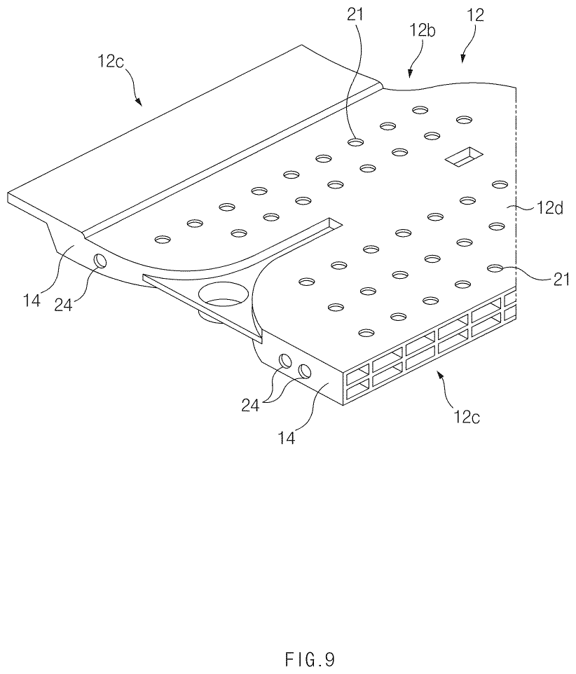

Referring to FIG. 9, the plurality of outlet holes 24 may be provided in the rear end wall 14. FIG. 9 illustrates two right outlet holes 24 and one left outlet hole 24 provided in the rear end wall 14.

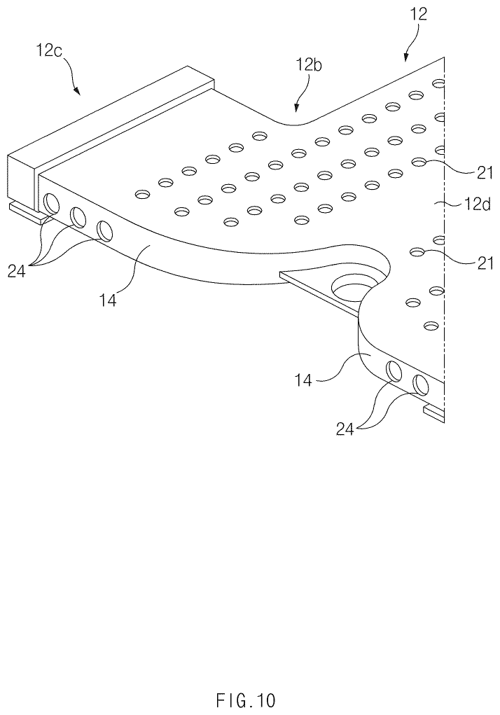

Referring to FIG. 10, the plurality of outlet holes 24 may be provided in the rear end wall 14. FIG. 10 illustrates two right outlet holes 24 and three left outlet holes 24 provided in the rear end wall 14.

Referring to FIGS. 8 to 10, at least a portion of the air flowing along the longitudinal direction of the second duct 12 in the interior space of the second duct 12 may be directed toward the rear of the vehicle through the plurality of outlet holes 23 and 24. Since the flow direction of the air passing through the plurality of outlet holes 23 and 24 is parallel to the longitudinal direction of the second duct 12, straightness of the air flow may be secured. Accordingly, the flow rate of the air passing through the plurality of outlet holes 23 and 24 may increase.

The rear end wall 14 of the second duct 12 may be disposed to face guide passages 33 and 34 of the carpet pad 31, and accordingly the plurality of outlet holes 23 and 24 may directly communicate with the guide passages 33 and 34.

According to an exemplary embodiment, the front portion 12a of the second duct 12 may be integrally connected to the rear portion 11b of the first duct 11 so that the first duct 11 and the second duct 12 may form a unitary one-piece structure.

According to another exemplary embodiment, the first duct 11 and the second duct 12 may be manufactured individually, and the front portion 12a of the second duct 12 and the rear portion 11b of the first duct 11 may be connected through a connector 13. As the first duct 11 and the second duct 12 are manufactured individually, the manufacturing of the first duct 11 and the second duct 12 may be easily performed.

Referring to FIG. 2, crossmembers 7 and 8 may extend in a width direction of the floor 1, and the first duct 11 may be supported to the crossmembers 7 and 8. The rear portion 11b of the first duct 11 may be bent, and the rear portion 11b of the first duct 11 may be supported to the crossmember 7. The first duct 11 may have a ridge portion 25 raised upward from a portion thereof adjacent to the front portion 11a, and the ridge portion 25 may be seated on the crossmember 8. A bottom surface of the ridge portion 25 may be higher than a bottom surface of the other portion of the first duct 11 by a predetermined height h. Accordingly, when moisture and the like flows in through the upper holes 21 and the lower holes 22 of the second duct 12, the ridge portion 25 may prevent moisture from flowing into the front opening 11c of the first duct 11.

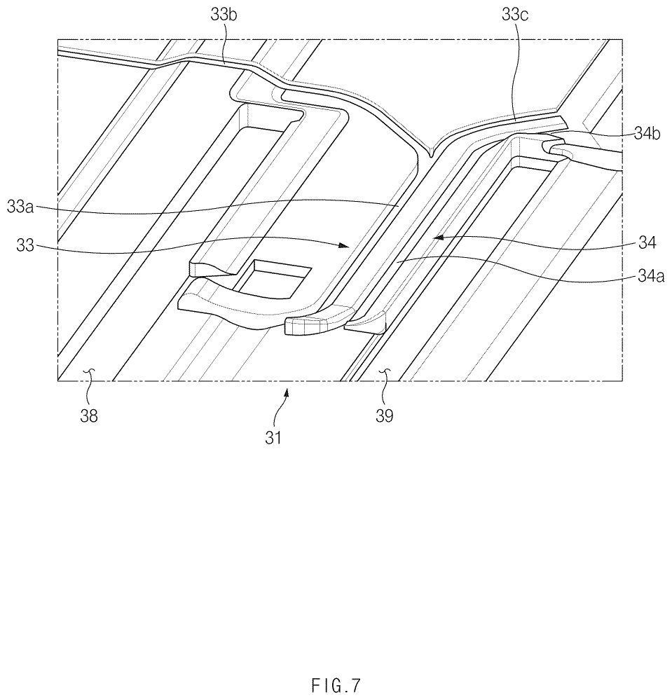

Referring to FIGS. 2 and 7, the carpet pad 31 may have a size corresponding to that of the floor 1 so as to cover the entirety of the top surface of the floor 1. The carpet pad 31 may have recesses in which the first duct 11 and the second duct 12 are received, and the recesses may be recessed from a bottom surface of the carpet pad 31 toward the top surface of the carpet pad 31. Referring to FIG. 7, the carpet pad 31 may have a pair of openings 38 and 39 into which the seat rails 18 and 19 are inserted, respectively.

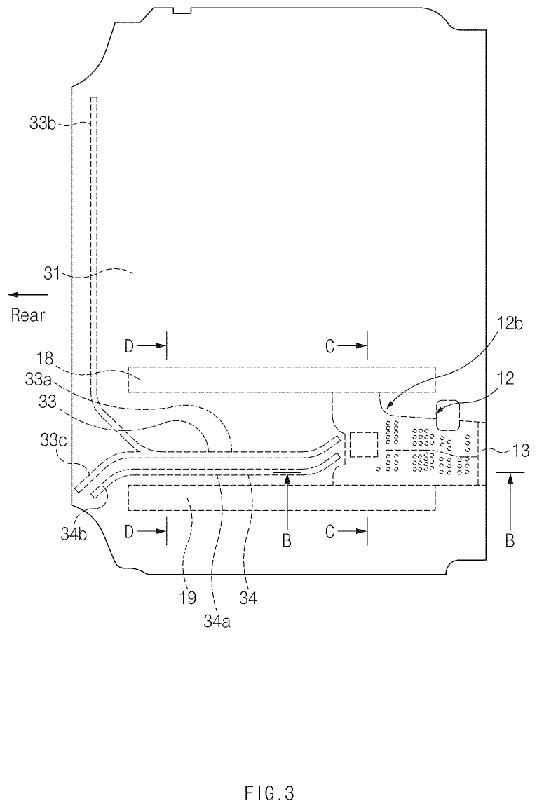

The carpet pad 31 may include one or more guide passages 33 and 34 extending from a portion of the carpet pad 31 adjacent to the ducts 11 and 12 to a side edge of the floor 1. Referring to FIG. 3, the carpet pad 31 may include two guide passages 33 and 34 provided in a portion thereof adjacent to the rear portion 12b of the second duct 12, and the guide passages 33 and 34 may extend from the rear portion 12b of the second duct 12 to both side edges of the floor 1.

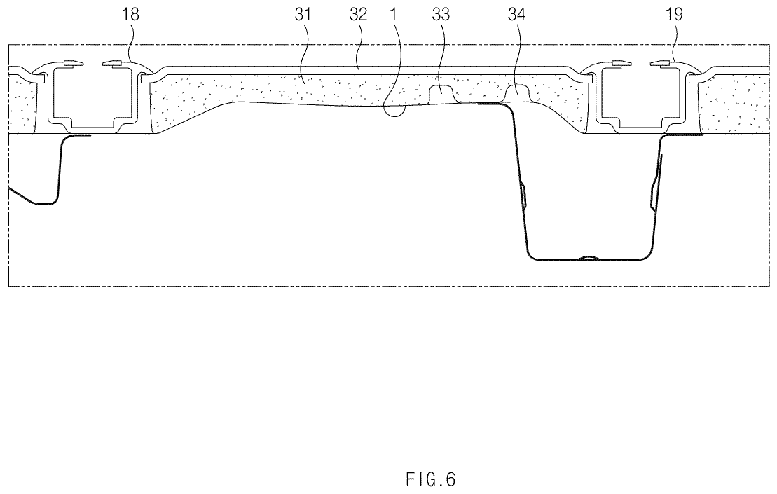

Referring to FIGS. 3 and 7, the two guide passages 33 and 34 may be integrally formed with the carpet pad 31. The two guide passages 33 and 34 may have a groove shape extending from the rear portion 12b of the second duct 12 to both side edges of the floor 1. Referring to FIGS. 6 and 7, each of the guide passages 33 and 34 may have a groove-shaped cross section recessed from the bottom surface of the carpet pad 31 toward the top surface of the carpet pad 31. That is, since each of the guide passages 33 and 34 is integrally formed with the carpet pad 31, a separate guide duct may not be required, which may relatively reduce the manufacturing cost.

Referring to FIGS. 3 and 7, the right guide passage 33 may extend from a portion of the carpet pad 31 adjacent to the outlet holes 23 and 24 of the rear portion 12b of the second duct 12 to both side edges of the floor 1. The right guide passage 33 may have a first area 33a extending from the rear portion 12b of the second duct 12 toward the rear of the vehicle in the longitudinal direction of the vehicle, a second area 33b extending from an end of the first area 33a to the right side edge of the floor 1, and a third area 33c extending from the end of the first area 33a to the left side edge of the floor 1.

Referring to FIGS. 3 and 7, the left guide passage 34 may extend from a portion of the carpet pad 31 adjacent to the outlet holes 23 and 24 of the rear portion 12b of the second duct 12 to the left side edge of the floor 1. The left guide passage 34 may have a first area 34a extending from the rear portion 12b of the second duct 12 toward the rear of the vehicle in the longitudinal direction of the vehicle, and a second area 34b extending from an end of the first area 34a to the left side edge of the floor 1.

The air discharged from the outlet openings 12c, the plurality of upper holes 21, the plurality of lower holes 22, and the plurality of outlet holes 23 and 24 of the second duct 12 may be guided to the side edges of the floor 1 through the guide passages 33 and 34.

As the air discharged from the second duct 12 is guided to the side edges of the floor 1 through the guide passages 33 and 34, noise, vibration, and heat of the air heated by the battery assembly 2 may be prevented from being delivered to the passengers occupying the passenger compartment. In particular, as the air is guided from the second duct 12 to the side edges of the floor 1 through the guide passages 33 and 34, the flow rate of the air discharged from the second duct 12 may relatively increase, and thus the flow rate of the air flowing into the battery case 2a of the battery assembly 2 may increase. Accordingly, the cooling of the plurality of battery cells (battery cooling performance) may be improved.

As set forth above, the duct structure for an air-cooled battery according to exemplary embodiments of the present disclosure may be designed to moderately change the pressure and air speed at the outlet opening of the duct by providing the plurality of holes (each hole having a diameter less than the opening area of the outlet opening) in a portion of the duct adjacent to the outlet opening through which the air flowing out from the vehicle battery assembly is discharged to the floor of the vehicle, thereby minimizing the generation of noise and/or vibration at the outlet opening.

According to exemplary embodiments of the present disclosure, the heated air flowing out from the battery assembly may be guided to the side edge(s) of the floor through the guide passage(s) of the carpet pad so that noise, vibration, and heat of the air heated by the battery assembly may be prevented from being delivered to the passengers in the passenger compartment.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

1. A duct structure for an air-cooled battery, the duct structure comprising:
a duct configured to guide air flowing out from a battery assembly disposed under a floor of a vehicle in a longitudinal direction of the vehicle; and
a carpet pad covering the duct;
wherein the carpet pad includes a guide passage extending from a portion of the carpet pad adjacent to the duct to a side edge of the floor of the vehicle.

2. The duct structure according to claim 1, wherein the guide passage has a groove-shaped cross section recessed from a bottom surface of the carpet pad toward a top surface of the carpet pad.

3. The duct structure according to claim 1, wherein the carpet pad is made of a foam material.

4. The duct structure according to claim 3, further comprising a carpet skin covering the carpet pad, wherein the carpet skin is made of a fabric material.

5. The duct structure according to claim 1, wherein the duct includes a pair of outlet openings which are open to both sides of the vehicle.

6. The duct structure according to claim 5, wherein the duct further includes at least one outlet hole positioned between the pair of outlet openings.

7. The duct structure according to claim 6, wherein the guide passage extends from the portion of the carpet pad adjacent to the outlet hole to the side edge of the floor.
